(19) United States
(12) Patent Application Publication
(10) Pub. No.: US 2015/0095405 A1
(43) Pub. Date: Apr. 2, 2015

(54) SELF-ADAPTIVE WORKLOAD SOLAR MODE COMPUTING OPTIMIZER SYSTEM FRAMEWORK FOR GREEN HYBRID SERVERS

(71) Applicant: Jack J. Sun, Palo Alto, CA (US)

(72) Inventor: Jack J. Sun, Palo Alto, CA (US)

(21) Appl. No.: 14/040,713

(22) Filed: Sep. 29, 2013

(51) Int. Cl. H04L 29/08

(52) U.S. Cl. CPC H04L 67/10
USPC 709/203

(57) ABSTRACT

An apparatus and method for self-adaptive software workload and service green power mode computing optimizer system framework at data center, and a companion “Green Flag” mechanism for general consumer or computing device end users that are coupled with green hybrid servers, to enable software executions to directly utilize solar PV power as much as possible, and so help deliver the environmentally sustainable way of cloud computing.

### FIELD OF THE INVENTION

This invention relates to the design of a self-adaptive computing workload management system coupled with the green hybrid server to maximize the utilization of green solar power for software computing tasks. The present invention relates particularly to the method and algorithm for the green hybrid powered computer servers to analyze, control, distribute, balance, and allocate workloads to maximize green energy utilization and so facilitating the environmentally sustainable cloud computing.

### BACKGROUND OF THE INVENTION

From this inventor, patent application Ser. Nos. 13/372,479, 13/436,663 and 13/462,281 disclosed the methods to directly utilizing solar PV electricity at ultimate efficiency for data center, for power supply and for the Green Hybrid Server.

During the implementation, design, prototyping and experiment efforts in preparing above mentioned three patents applications, it was noticed that on the new Green Hybrid Server platform, a new kind of software workload management method is need and, to certain degree, critical to get most of the benefits out of the solar PV electricity that power a green Hybrid Server system. This new self-adaptive workload optimizer for green hybrid servers uses the invented functions disclosed in above mentioned three patents applications, and can be implemented in form of either hardware or software, or a combination of both hardware and software.

Notice that in current computer server system operation, workload execution scheme is not aware of the green energy source provided by the green hybrid server, and so making execution decision without considering the green energy status. Thus, the green power will not be utilized in the optimized way, and many workloads that could be executed consuming the green power, end up with still consuming the traditional grid power. Typical workload examples and scenarios include but not limited to:
Group email notifications to millions users or customers for a new product promotion may sent in evening time;
Bulk transactions and consolidation processing may scheduled in early morning;
Big data mining and analyzing tasks may be scheduled overnight;
Servers may be idle during lunch time, where solar energy is usually at peak.
   Above workloads and scenarios will have very high chance using grid power when solar power is weakest, given solar power is stored in battery with additional cost and overhead.

Another important fact is that different software workloads are usually consuming computing resources and power differently, in terms of CPU utilization, Memory consumption, Disk and other operations. So without a smart workload management system that understands the workload energy characteristics, a green hybrid server may not deployed, configured and utilized in an optimized and targeted way, especially when in reality the hybrid servers are usually partially deployed initially in an existing data center where different clusters may serve different operations and functions.

### SUMMARY OF THE INVENTION

This invention presents the method and apparatus for a self-adaptive Software workload green power mode computing optimizer system framework, and the companion end user “Green Flag” mechanism that are coupled with hybrid servers to ensure as much as possible software workloads executed directly using solar PV power, in the environmentally sustainable way with better consumers satisfaction.

### BRIEF DESCRIPTION OF THE DRAWINGS

FIG. 1 illustrates the green hybrid computer servers execute workloads, With a typical data center architecture, without optimizing green power source. The hybrid mechanism was disclosed in the inventor's patent application Ser. No. 13/462,821.

FIG. 2 illustrates the function of the self-adaptive workload green power optimizer framework and companion green flag of this Invention, coupled with the green hybrid server which was disclosed in patent application Ser. No. 13/462,821.

FIG. 3 illustrates the self-adaptive workload optimizer framework key Logics that enable the green hybrid server to execute as much as possible workloads directly consuming the green solar PV power, or direct solar mode computing, provided by the green hybrid server.

### DETAILED DESCRIPTION OF THE DRAWINGS

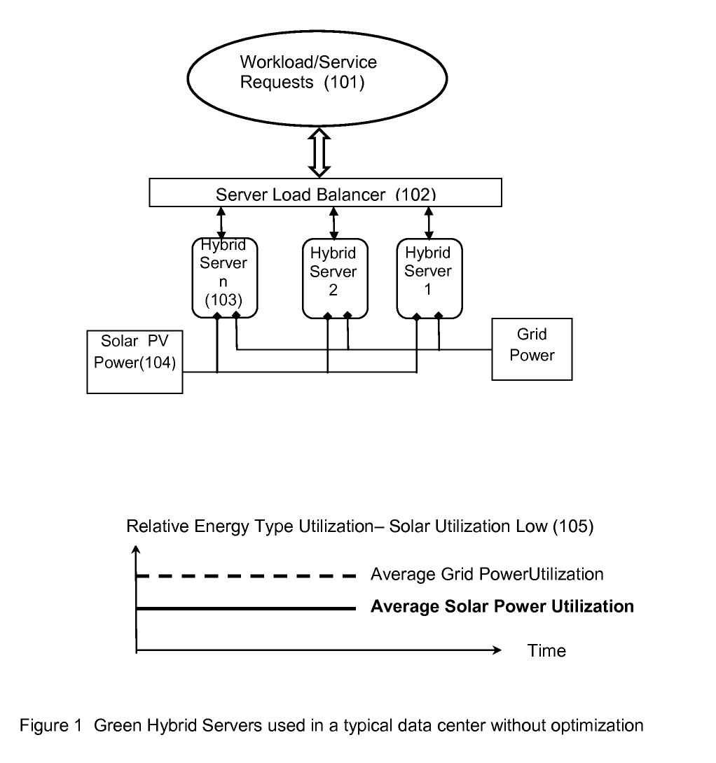

FIG. 1 illustrates the green hybrid computer servers execute workloads in a typical current data center deployment architecture. Tag (101) indicates that the service and workload requests are from network or internet. Server loadbalancer is used to distribute load among servers as shown in Tag (102). The green hybrid servers are deployed and serve the workload requests as shown in Tag (103). The green hybrid power source is from solar PV shown in Tag (104). Without a prefer energy mode computing method, the current system in general may use much less green solar power than possible, as illustrated in Tag (105), where solar power utilization in solid line is lower than grid power utilization in dotted line.

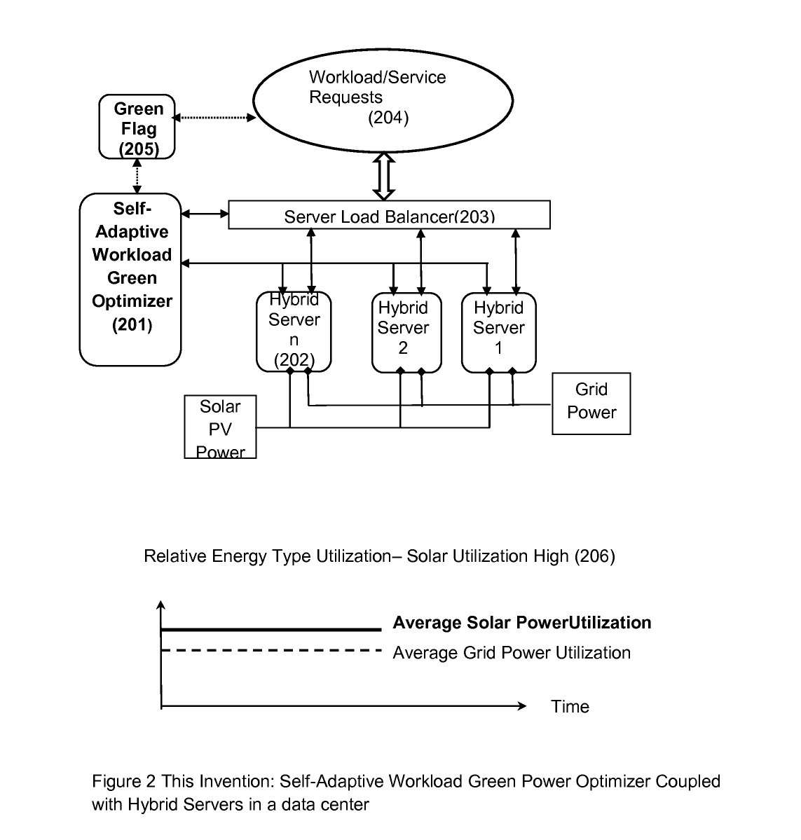

FIG. 2 shows this Invention Self-Adaptive Workload Green Power Optimizer coupled with Hybrid Servers. The Optimizer shown in Tag (201) communicate with Hybrid Servers Tag (202) and loadbalancerTag (203), Green Flag Tag (205) to make optimal workload execution decisions based on solar power status, workload energy characteristics, end user green computing requirement and other business or technical conditions. The benefit of the Invention is illustrated in Tag (206) where solar utilization is higher and can be higher than grid power utilization in certain time for certain workloads. Note the two power utilization graphs in Tag (206) and (105) intend to show the designed impact qualitatively, where specific quantitative impact depends on site location, business patterns and other technical operation configurations.

The invented system will operate more efficiently by providing end users the choice to mark their software workload or service requests as “Prefer Green Computing”. The Green Flag shown in Tag (205) is a short formatted data embedded in users requests such as in an internet browser's HTTP request header, and then in the data center, optimizer Tag (201) will check this green flag as an additional condition to process related workloads with high green power usage priority.

This Green Flag can be implemented and offered in different level or scope to facilitate the general public's growing concern about environmental sustainable IT. For example the Green Flag can be set at software program level which enables the specified software program such as email; or at device host level which enables all software workloads or service requests from a computing device such as a laptop computer or a cell phone; or at organization level which enables all software workloads or service requests from, say, a middle school.

The dotted line connections among Tag (201), Tag (204) and Tag (205) indicates that such green flag implementation can be started with individual software service vendors and may eventually adopted by the whole internet and computing industry. One of the typical usage scenarios of this invention is that a user set his or her cell pone's text message program with the Green Flag, then all the user's test message will be processed with high priority via solar mode computing provided by the hybrid servers.

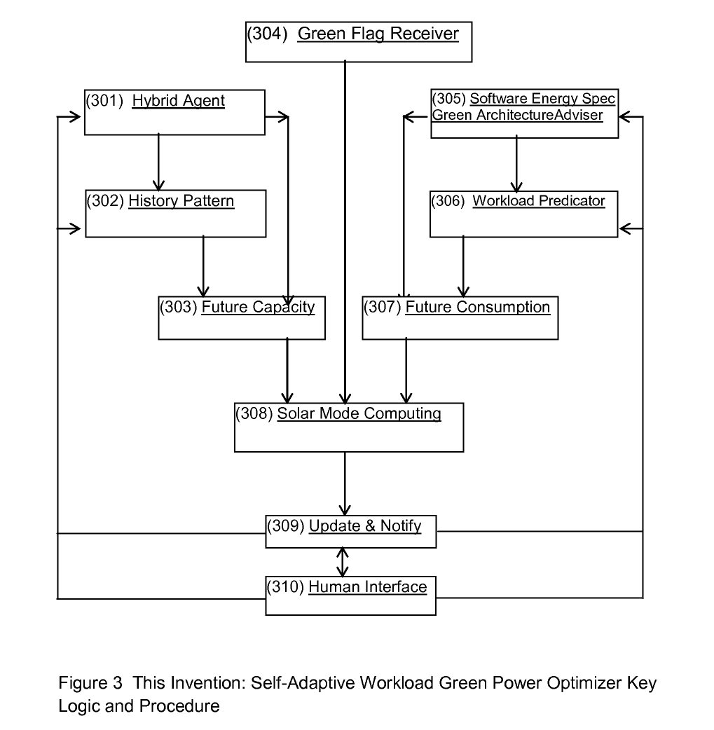

FIG. 3 explains the key logics of the invention illustrated in FIG. 2. The Hybrid Agent Tag (301) resides at hybrid server (which was disclosed at application Ser. No. 13/462,821 FIG. 3, tag 302, data logging), collects and provides live daily solar energy status. The data includes timestamps; powered subsystem—i.e. CPU, Memory, Disk or all of them; electrical voltage; electrical current; weather forecast info; and other concerned business and technical parameters. The Agent update status data at a predefined frequency. History Pattern Tag (302) is the collection of history data about the solar energy supply and the solar energy usages, the historical data help make predication and estimation more accurate, given solar power changes over time. Future Capacity Tag (303) makes the forward estimation about available solar power capacity based on data from Tag (301) and Tag (302).

Tag (304) is the end user green flag receiver that checks the flag and direct the end users workload and software service requests to Solar Mode Computing Tag (308), and processed with high priority to make sure users green computing requirements executed.

Software Energy Spec Tag (305) collects, updates and provides the workload energy characteristics data such as average power consumption, required service level agreement, and other business or technical concerns. The data collection will involve certain benchmarking and testing, as well as calibration efforts. Based on known server load and energy consumption pattern and business Requirement. It also serves as the Green Architecture Adviser provides data center system-wide green power optimization strategy for servers deployment and configuration. For example, if not yet, then setup the business email services software using green hybrid server to serve the typical 9 AM-5 PM heavy load, when solar power is usually available.

Tag (306) is the Workload Predicator, which collects and provides the daily anticipated workload and software service or application status such as known execution elapsed time, next execution time, previous usage of solar power and other business or technical concerns. Future Consumption Tag (307) generates the list of suitable workloads that can be executed directly consuming solar power, based on the information from (305) and (306).

Solar Mode Computing Tag (308) will analysis, match, and make schedule or execution decisions based on the information from (303) and (307), with the goal of directly and fully utilized available solar power, while keeping the software service level agreement and end users green computing preference. The workload requests with the flag “Prefer Green Power” from Tag (304) will have high priority in utilizing the solar mode computing. Workloads that are not executed under solar mode will be executed at grid power mode at same hybrid server if schedule fits, or executed at other traditional servers that always powered by grid.

Update & Notify Tag (309) will dynamically update the related system modules so that at any given time, all workloads execution status is correct. Human Interface Tag (310) enables data center admin staff to manage the system and apply controls that can overwrite any rules in case there is a need.

What is claimed is:

1. A method comprising:
A self-adaptive software and service workload execution green power mode computing optimizer system framework, that is coupled with green hybrid servers to enable more efficient solar PV power utilization at a data center.

2. A method comprising:
A Green Flag mechanism coupled with the self-adaptive computer green Power mode computing optimizer framework, which offers the end users or general consumers the choice to mark their software workload or service requests as “Prefer Green Computing”, and then such requests will enjoy high priority to be processed under the direct solar power mode computing provide by hybrid servers.
